(19) United States
(12) Patent Application Publication
(10) Pub. No.: US 2025/0309310 A1
(43) Pub. Date: Oct. 2, 2025

(54) POWER GENERATION CELL AND FUEL CELL STACK

(71) Applicant: Honda Motor Co., Ltd., Tokyo (JP)

(72) Inventors: Yuta Oshima, Saitama (JP); Kodai Kawamoto, Saitama (JP)

(21) Appl. No.: 19/063,226

(22) Filed: Feb. 25, 2025

(30) Foreign Application Priority Data
Mar. 29, 2024 (JP) 2024-058111

(51) Int. Cl. H01M 8/242; H01M 8/0206; H01M 8/0254; H01M 8/0273; H01M 8/0284; H01M 8/1004

(52) U.S. Cl. CPC H01M 8/242; H01M 8/0206; H01M 8/0254; H01M 8/0273; H01M 8/0284; H01M 8/1004

(57) ABSTRACT

A membrane electrode structure including a membrane electrode assembly and a frame member made of resin supporting the membrane electrode assembly, the membrane electrode structure having an electrolyte membrane and an electrode, and a separator made of metal, disposed facing the membrane electrode structure, the separator being configured to form a flow path for a reaction gas to flow between the membrane electrode structure and the separator. The frame member includes a first region having an outer edge portion of the frame member, a second region located inside the first region, and a protruding portion provided in the first region and extending outward beyond an outer edge of the separator, and a thickness of the frame member in the first region where the protruding portion is located, is larger than a thickness of the frame member in the second region.

### CROSS-REFERENCE TO RELATED APPLICATION

This application is based upon and claims the benefit of priority from Japanese Patent Application No. 2024-058111 filed on Mar. 29, 2024, the content of which is incorporated herein by reference.

### BACKGROUND OF THE INVENTION

### Field of the Invention

This invention relates to a power generation cell and a fuel cell stack for a fuel cell.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, there is a known technology in which a restraining member is provide between a cell stacked body and a case to restrain the position of the cell stacked body. Such technology is described, for example, in Japanese Examined Patent Publication No. 6870603 (JP 6870603 B). In the technology described in JP 6870603 B, a resin restraining member is disposed in contact with the outer side surface of the cell stacked body.

However, the edge of a separator made of a thin metal plate is positioned on the outer side surface of the cell stacked body. Therefore, repeated contact between the cell stacked body and the restraining member caused by external impacts may lead to wear on the restraining member, potentially generating resin powder around the cell stacked body, which could adversely affect power generation performance.

### SUMMARY OF THE INVENTION

An aspect of the present invention is a power generation cell including a membrane electrode structure including a membrane electrode assembly and a frame member made of resin to support the membrane electrode assembly, the membrane electrode structure having an electrolyte membrane and an electrode, and a separator made of metal, disposed facing the membrane electrode structure, the separator being configured to form a flow path for a reaction gas to flow between the membrane electrode structure and the separator. The frame member includes a first region having an outer edge portion of the frame member, a second region located inside the first region, and a protruding portion provided in the first region and extending outward beyond an outer edge of the separator, and a thickness of the frame member in the first region where the protruding portion is located, is larger than a thickness of the frame member in the second region.

Another aspect of the present invention is a fuel cell stack including a cell stacked body including a plurality of power generation cells stacked in a predetermined direction, a housing surrounding the cell stacked body, and a positioning member supported by the housing to restrict a movement of the cell stacked body in a plane orthogonal to the predetermined direction. Each of the plurality of power generation cells is the above power generation cell, the frame member has a substantially rectangular plate shape, and an outer edge of the protruding portion is disposed in contact with or in proximity to the positioning member.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack including a power generation cell stack according to an embodiment of the present invention;

FIG. 2 is a cross-sectional view showing a configuration of a main part in a power generation region of a cell stacked body included in the fuel cell stack in FIG. 1;

FIG. 3 is an exploded perspective view of a unit cell included in the fuel cell stack in FIG. 1;

FIG. 4 is a cross-sectional view taken along line IV-IV of FIG. 1;

FIG. 5 is an enlarged view of a part V of FIG. 4, showing an example of a reinforcing member;

FIG. 6 is a cross-sectional view taken along line VI-VI of FIG. 5;

FIG. 7 is a view illustrating a bonding process of the reinforcing member included in a manufacturing process for the power generation cell;

FIG. 8 is a view illustrating a modification of FIG. 4;

FIG. 9A is a plan view illustrating a configuration of a unitized electrode assembly included in the power generation cell according to the embodiment of the present invention, which differs from that shown in FIG. 4;

FIG. 9B is a view illustrating a first modification of FIG. 9A;

FIG. 9C is a view illustrating a second modification of FIG. 9A;

FIG. 9D is a view illustrating a third modification of FIG. 9A;

FIG. 10 is a view illustrating an example of the reinforcing member different from the one shown in FIG. 5;

FIG. 11 is a cross-sectional view taken along line XI-XI of FIG. 10;

FIG. 12 is a view illustrating a bonding process of the reinforcing member;

FIG. 13 is a view illustrating a joining process; and

FIG. 14 is a view illustrating a modification of FIG. 10.

### DETAILED DESCRIPTION OF THE INVENTION

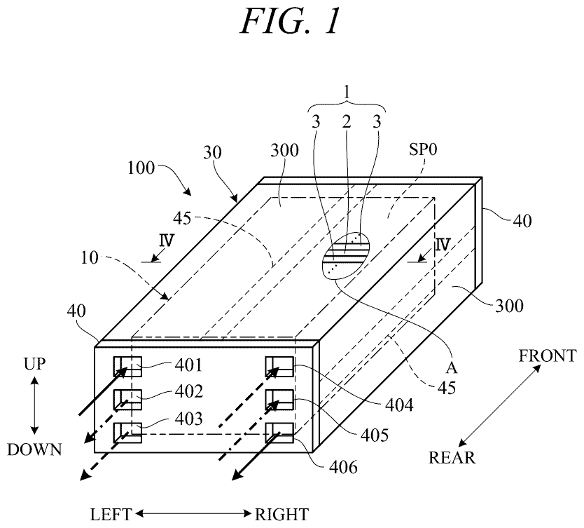

Hereinafter, an embodiment of the present invention will be described with reference to FIGS. 1 to 9D. A power generation cell according to an embodiment of the present invention is included in a fuel cell stack that is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions may be different from a front-rear direction, a left-right direction, and an up-down direction of the vehicle. The front-rear direction in FIG. 1 is a stacking direction of the fuel cell stack 100, and when assembling the fuel cell stack 100, the stacking direction is aligned with the direction of gravity.

As illustrated in FIG. 1, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape. The length of the fuel cell stack 100 in the left-right direction is longer than the length in the up-down direction.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron.

In part “A” of FIG. 1, a portion of the side wall 300 of the case 30 is shown as broken. As illustrated in part “A” of FIG. 1, the cell stacked body 10 is a stacked body including a plurality of power generation cells 1 (for convenience, only a single cell 1 is illustrated) disposed in the housing space SP0.

The power generation cell 1 has a unitized electrode assembly (hereinafter, referred to as a “UEA”) 2 including a membrane electrode assembly having an electrolyte membrane and an electrode, and separators 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member. In the central part of the power generation cell 1 in the left-right direction and in the central part of the power generation cell in the up-down direction, a power generation region is formed where electricity is generated through the electrochemical reaction of hydrogen and oxygen.

A plurality of guide members 45 (only partially shown) are interposed between the cell stacked body 10 and side walls 300 of the case 30. The guide member 45 is a rod-like or plate-like member extending in the front-rear direction, and is attached in advance to the inner surface of the side wall 300. The guide member 45 is previously attached to each of the inner surfaces of the four side walls 300 (the inner wall of the case 30), and the cell stacked body 10 is assembled in this state. During assembly of the fuel cell stack 100, for example, the rear end unit 40 is laid sideways, and a plurality of power generation cells 1 guided by the guide members 45 are stacked thereon to assemble the cell stacked body 10. Then, the front end unit 40 is mounted on the cell stacked body 10.

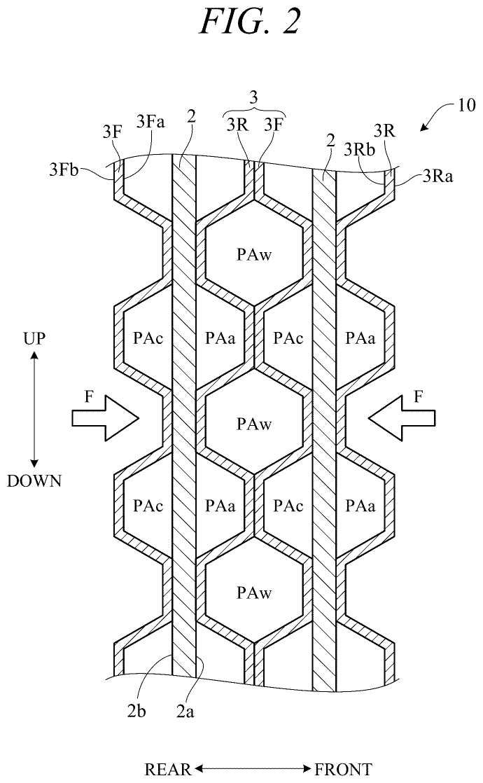

FIG. 2 is a cross-sectional view showing a configuration of a main part in the power generation region of the cell stacked body 10, and more specifically, it is a cross-sectional view cut along a plane extending in the up-down and front-rear directions. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb.

The rear surface 3Fb of the front plate 3F and the front surface 3Ra of the rear plate 3R facing each other are joined together by welding (thermal bonding) or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling flows is formed. The generating surface of the power generation cell 1 is cooled by the flow of the cooling medium. Water, for example, can be used as the cooling medium. The surfaces of the separator 3 facing the UEA 2, that is, the front surface 3Fa of the front plate 3F and the rear surface 3Rb of the rear plate 3R, are formed into an uneven shape by press molding or the like to form a gas flow path between the separator 3 and the UEA 2.

More specifically, between the front surface 2a of the UEA 2 and the rear plate 3R of the separator 3 facing this front surface 2a, an anode flow path PAa through which fuel gas including hydrogen (anode gas) flows is formed. Between the rear surface 2b of the UEA 2 and the front plate 3F of the separator 3 facing this rear surface 2b, a cathode flow path PAc through which oxidant gas including oxygen (cathode gas) flows is formed. The fuel gas and the oxidant gas may be referred to as a reaction gas without being distinguished from each other. In the cell stacked body 10, a compressive load F is applied in the front-rear direction during the assembly of the fuel cell stack 100. After the assembly of the fuel cell stack 100 is completed, the pair of front and rear end units 40 are fastened to the case 30, thereby maintaining the compressive load F.

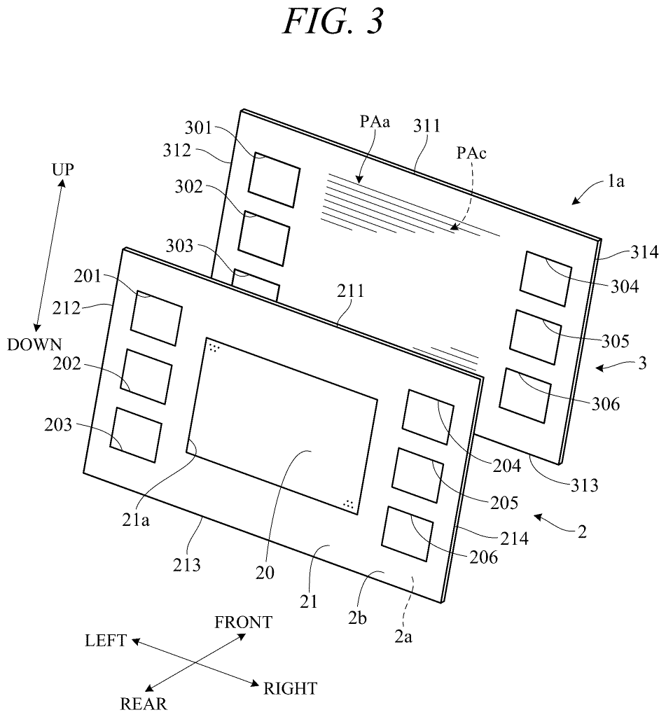

A single UEA 2 and a single separator 3 are integrally joined in advance by welding (thermal bonding) to form a unit cell (a cell unit). FIG. 3 is an exploded perspective view of the unit cell 1a showing the schematic configuration of the UEA 2 and the separator 3. The unit cell 1a is formed by joining the pair of plates 3F and 3R to form the separator 3, and then, for example, overlaying the rear plate 3R of the separator 3 on the front surface 2a of the UEA 2. Although not shown in FIG. 3, a positioning portion for positioning the UEA 2 and the separator 3 during welding is provided on outer edge portions of the UEA 2 and the separator 3.

As shown in FIG. 3, the UEA 2 includes a membrane electrode assembly 20 (hereinafter, referred to as a “MEA”) and a resin film 21. The MEA 20 has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path PAa (FIG. 2) and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path PAc (FIG. 2) and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2.

The resin film (frame) 21 has a substantially rectangular shape, with its outer edge formed by four sides (upper side 211, left side 212, lower side 213, and right side 214). The resin film 21 is made of a resin material with insulation property, such as PPS (polyphenylene sulfide) or PEN (polyethylene naphthalate). A substantially rectangular opening 21a is provided in a central portion of the resin film 21. The MEA 20 is disposed to cover the entire opening 21a and a peripheral portion of the MEA 20 is supported by the resin film 21. Three through-holes 201 to 203 penetrating the resin film 21 in the front-rear direction are opened side by side in the up-down direction on the left side of the opening 21a of the resin film 21. Three through-holes 204 to 206 penetrating the resin film 21 in the front-rear direction are opened side by side in the up-down direction on the right side of the opening 21a of the resin film 21.

The separator 3 has a substantially rectangular shape overall, with its outer edge formed by four sides (upper side 311, left side 312, lower side 313, and right side 314). The separator 3 forms uneven cathode flow paths PAc (FIG. 2) and uneven anode flow paths PAa (FIG. 2) on the front and rear surfaces facing the MEA 20, respectively. In the separator 3, through-holes 301 to 306 penetrating the separator 3 in the front-rear direction are opened at positions corresponding to the through-holes 201 to 206 of the resin film 21. The through-holes 301 to 306 communicate with the through-holes 201 to 206 of the resin film 21, respectively. The set of these through-holes 201 to 206, 301 to 306, which communicate with each other, forms a plurality of flow paths penetrating the cell stacked body 10 and extending in the front-rear direction.

As shown in FIG. 1, in the rear end unit 40, a plurality of through-holes 401 to 406 penetrating the end unit 40 in the front-rear direction are opened at positions corresponding to the through-holes 201 to 206 and 301 to 306. In the front end unit 40, the through-holes 401 to 406 are not opened.

A fuel gas tank storing high-pressure fuel gas is connected to the through-hole 401 via an ejector, an injector, etc., and the fuel gas is supplied to the fuel cell stack 100 through the through-hole 401, as shown by a solid arrow. This fuel gas is guided to the anode flow path PAa through the through-holes 201 and 301. The fuel gas after passing through the anode flow path PAa is discharged from the through-hole 406 through the through-holes 206 and 306, as shown in a solid arrow.

A compressor for supplying oxidant gas is connected to the through-hole 404, and the oxidant gas compressed by the compressor is supplied to the fuel cell stack 100 through the through-hole 404, as shown in a dotted arrow. This oxidant gas is guided to the cathode flow path PAc through the through-holes 204 and 304. The oxidant gas after passing through the cathode flow path PAc is discharged from the through-hole 403 through the through-holes 203 and 303, as shown in a dotted arrow.

A pump for supplying cooling medium is connected to the through-hole 405, and the cooling medium is supplied to the fuel cell stack 100 through the through-hole 405, as shown in a chain arrow. This cooling medium is guided to the cooling flow path PAw between the front plate 3F and the rear plate 3R of the separator 3 through the through-holes 205 and 305. The cooling medium after passing through the cooling flow path PAw is discharged from the through-hole 402 through the through-holes 202 and 302, as shown in a chain arrow.

A schematic configuration of the fuel cell stack 100 has been described above. The present embodiment is characterized by the configuration of the outer edge portion of the UEA 2, particularly the configuration of the positioning portion. Hereinafter, this configuration will be described.

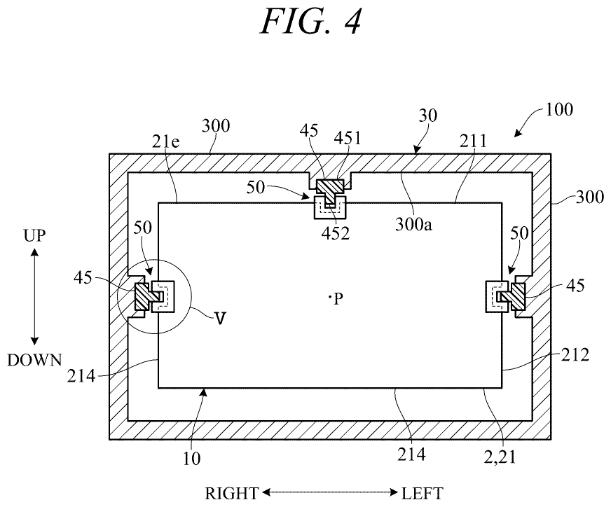

FIG. 4 is a cross-sectional view taken along line IV-IV of FIG. 1. FIG. 4 includes a front view (a view viewed from the front) of the UEA 2. In the following description including FIG. 4, for convenience, only the outer edge portion of the resin film 21 is illustrated as the UEA 2, and illustration of the MEA 20 and the through-holes 201 to 206 may be omitted. FIG. 4 illustrates a center point P which is the center in the left-right direction and the center in the up-down direction of the cell stacked body 10. Hereinafter, a side toward the center point P may be referred to as an inside, and a side away from the center point P may be referred to as an outside.

As illustrated in FIG. 4, a guide member 45 is interposed between an outer edge 21e of a resin film 21 of the UEA 2 and an inner wall surface 300a of a side wall 300 of a case 30. Specifically, the guide members 45 are interposed between an upper side 211 and the inner wall surface 300a, between a left side 212 and the inner wall surface 300a, and between a right side 214 and the inner wall surface 300a of the resin film 21. A positioning portion 50 is provided on the outer edge 21e of the resin film 21, and the guide member 45 is fitted to the positioning portion 50.

The positioning portion 50 is provided at each of the central portion in the left-right direction of the upper side 211 of the resin film 21, the central portion in the up-down direction of the left side 212, and the central portion in the up-down direction of the right side 214. The positioning portion 50 may be provided in a portion other than the central portion of each of the sides 211, 212, and 214. The positioning portion 50 may be provided on a lower side 213, and the guide member 45 may be interposed between the lower side 213 and the inner wall surface 300a. The configurations of the plurality of guide members 45 and the plurality of the positioning portions 50 are the same as each other.

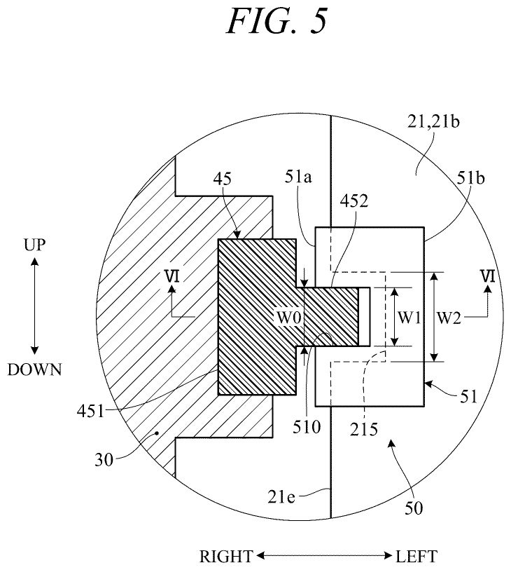

FIG. 5 is an enlarged view of a part V in FIG. 4. As illustrated in FIG. 5, the guide member 45 includes a base portion 451 having a substantially rectangular parallelepiped shape and a projection 452 protruding inward (the right side in FIG. 5) from the base portion 451, and has a substantially T-shaped cross section. The cross-sectional shape of the guide member 45 is constant over the entire length in the front-rear direction, and each of the front end portion and the rear end portion of the guide member 45 is supported by the recess or the through-hole of the end unit 40 in FIG. 1. The projection 452 of the guide member 45 is fitted to the positioning portion 50.

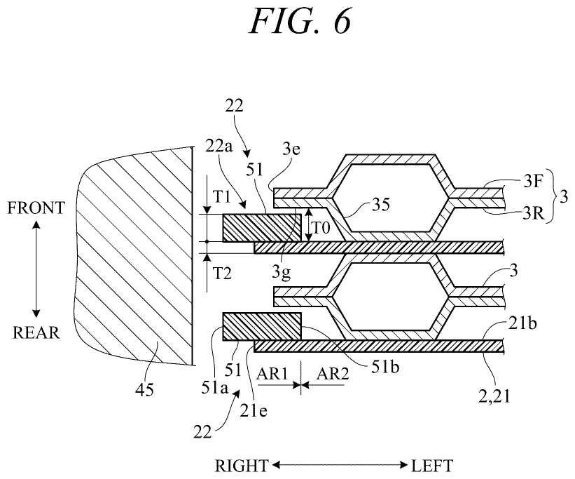

FIG. 6 is a cross-sectional view taken along line VI-VI of FIG. 5. As illustrated in FIGS. 5 and 6, the positioning portion 50 includes a reinforcing member 51 attached to a front surface 21b of the resin film 21. The reinforcing member 51 is made of an insulating resin material. For example, the reinforcing member 51 is made of the same material as the resin film 21. As illustrated in FIG. 5, the reinforcing member 51 has a substantially U shape in plan view as viewed from a stacking direction (front-rear direction), and is disposed to overlap a recess 215 so as to cover the recess 215 provided in the outer edge 21e of the resin film 21. A width W1 of a recess 510 of the reinforcing member 51 is smaller than a width W2 of the recess 215 of the resin film 21, and is equal to or substantially equal to (slightly smaller than W0) a width W0 of the projection 452 of the guide member 45. It is sufficient that W1 is equal to or less than W2, and W1 and W2 may be equal to each other.

The outer end portion (a right end portion in FIG. 5) of the reinforcing member 51, that is, an outer edge 51a protrudes outward from the outer edge 21e of the resin film 21, and the entire recess 215 of the resin film 21 is covered with the reinforcing member 51. The outer edge 51a of the reinforcing member 51 and the outer edge 21e of the resin film 21 may be located at the same position. There is a predetermined gap between the outer end surface (right end surface) of the reinforcing member 51 and the inner end surface (left end surface) of the base portion 451 of the guide member 45 facing the outer end surface, and between the outer end surface of the reinforcing member 51 and the inner end surface (left end surface) of the projection 452 of the guide member 45 facing the outer end surface, and the reinforcing member 51 is disposed close to the guide member 45. The reinforcing member 51 may be disposed to contact the guide member 45. That is, the gap may be 0.

As illustrated in FIG. 6, one end portion (outer edge 51a) of the reinforcing member 51 protrudes outward from the outer edge 3e of the separator 3, and the other end portion (inner edge 51b) is located inside the outer edge 3e of the separator 3. The resin film 21 to which the reinforcing member 51 is bonded is referred to as a reinforcing film 22. The outer edge portion of the reinforcing film 22 constitutes a protruding portion 22a protruding outward from the outer edge 3e of the separator 3. A thickness of a first region AR1 of the reinforcing film 22 including the outer edge of the protruding portion 22a (the outer edge 51a of the reinforcing member 51), that is, a thickness of the reinforcing film 22 in the region where the reinforcing member 51 is provided, is larger than a thickness of a second region AR2 inside the first region AR1, that is, a thickness of the reinforcing film 22 in the region where the reinforcing member 51 is not provided.

In other words, the reinforcing film 22, which is a joined body of the resin film 21 and the reinforcing member 51, has the reinforcing member 51 in the first region AR1 and does not have the reinforcing member 51 in the second region AR2. A thickness T1 of the reinforcing member 51 is larger than a thickness T2 of the resin film 21. As an example, the thickness T2 is 0.1 mm or less, and the thickness T1 is set within a range that is larger than 1 times the thickness T2 and is equal to or less than 2 times, 3 times, or 5 times the thickness T2. However, the thickness T1 is less than or equal to a height TO of a rib portion 35 of a rear plate 3R of the separator 3, that is, the height TO which is a length from a contact surface (front surface 21b) where the separator 3 is in contact with the resin film 21 to a horizontal surface (outer edge portion 3g) extending substantially parallel to the resin film 21. Therefore, the reinforcing member 51 constituting the thick portion of the reinforcing film 22 does not interfere with the separator 3.

The reinforcing member 51 can also be formed of a single or a plurality of substantially U-shaped resin films 21. That is, the tip portion (first region AR1) of the reinforcing film 22 can also be constituted by superimposing a single or a plurality of substantially U-shaped resin films 21 on the resin film 21 to form two or more layers of the resin film 21.

The inner edge 51b of the reinforcing member 51 may be located at the same position as that of the outer edge 3e of the separator 3 in the left-right direction of FIG. 6 or may be located on the right side of the outer edge 3e. Accordingly, since the reinforcing member 51 and the separator 3 do not interfere with each other regardless of the thickness of the reinforcing member 51, the thickness T1 of the reinforcing member 51 can be made larger than the height TO of the rib portion 35 of the separator 3. The reinforcing member 51 can be attached to the front surface 21b of the resin film 21 in various modes. In the present embodiment, the reinforcing member 51 is bonded to the front surface 21b via an adhesive. Since both the resin film 21 and the reinforcing member 51 are made of a resin material, the resin film and the reinforcing member can be easily and satisfactorily bonded to each other by the adhesive.

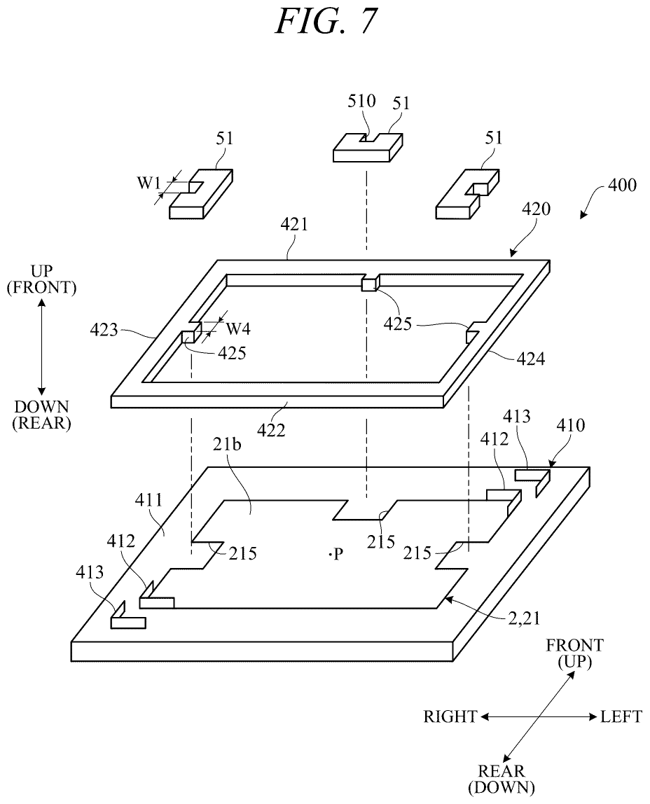

The reinforcing member 51 is positioned and bonded with respect to the resin film 21 by using a manufacturing apparatus. FIG. 7 is a perspective view illustrating a schematic configuration of the manufacturing apparatus 400, and is a view for mainly explaining a bonding process of the reinforcing member 51. The bonding is performed by tilting the UEA 2 sideways. Therefore, in the description regarding the bonding process, directions corresponding to the up-down direction and the front-rear direction (illustrated in parentheses in FIG. 7) in FIG. 1 are defined as the front-rear direction and the up-down direction as illustrated in FIG. 7, respectively. The lower side in the up-down direction in FIG. 7 corresponds to the direction of gravity.

As illustrated in FIG. 7, the manufacturing apparatus 400 includes a table 410 on which the UEA 2 is placed, and a frame 420 mounted on an upper surface 411 of the table 410. The table 410 has a substantially rectangular shape as a whole in plan view as viewed from above, and the entire UEA 2 provided with the recess 215 is placed on the upper surface 411 of the table 410. On the upper surface 411 of the table 410, a pair of guides 412 for regulating the position of the UEA 2 is provided to protrude upward.

The guide 412 is, for example, a plate member having a substantially L shape in plan view, and is provided corresponding to a pair of corners of the UEA 2. That is, the guide 412 protrudes from the upper surface 411 of the table 410 corresponding to the left and front corner and the right and rear corner of the UEA 2. The pair of corners of the UEA 2 abuts on the guide 412, thereby defining a relative position of the UEA 2 with respect to the table 410.

The frame 420 includes a pair of front and rear frame portions 421 and 422 parallel to each other and a pair of left and right frame portions 423 and 424 parallel to each other, and has a substantially rectangular frame shape as a whole in plan view. On the upper surface of the table 410, a pair of guides 413 for restricting the position of the frame 420 is further provided to protrude upward. The guide 413 is constituted by a plate member similarly to the guide 412, for example.

When the frame 420 is lowered, the frame 420 is lowered while positioning the pair of corners by the guide 413, and is mounted on the table. Accordingly, the position of the frame 420 with respect to the table 410, in other words, the relative position of the frame 420 with respect to the UEA 2 is defined.

Each of the inner edges of the frame portions 421, 423, and 424 is provided with a projection 425 protruding inward (toward the center point P) corresponding to the recess 215 of the UEA 2. The projection 425 has the same or substantially the same shape as the projection 452 of the guide member 45, and the relative position of the projection 425 with respect to the UEA 2 in a state where the frame 420 is mounted on the table, is the same as the relative position of the projection 452 with respect to the UEA 2 in FIG. 4. Therefore, the projection 425 is located inside the recess 215 of the UEA 2. A width W4 of the projection 425 is substantially equal to the width W1 of the recess 510 of the reinforcing member 51. Strictly, W4 is slightly smaller than W1.

After the frame 420 is mounted on the upper surface 411 of the table 410, the reinforcing member 51 is bonded to the resin film 21. That is, the reinforcing member 51 is bonded to the upper surface (the front surface in FIG. 5) 21b of the resin film 21 while the recess 510 of the reinforcing member 51 is positioned by being fitted to the projection 425 of the frame 420. Accordingly, the bonding process is completed.

The guide 412 for positioning the UEA 2 and the guide 413 for positioning the frame 420 may be provided integrally, or may be positioned using a single guide member. The guide 412 may protrude from the table 410 corresponding to the recess 215 instead of the corner of the resin film 21. The guide 413 may protrude corresponding to the projection 425 instead of the corner of the frame 420. The guides 412 and 413 may have substantially cylindrical pin shapes. A member corresponding to the projection 425 of the frame 420 may be fixed in advance to a predetermined position on the upper surface of the table. Alternatively, a bulging portion corresponding to the projection 425 may be provided in advance on the upper surface of the table. Accordingly, the reinforcing member 51 can be positioned without the frame 420.

When the bonding process is completed, a welding process of integrating the UEA 2 and the separator 3 by welding (thermal bonding) is performed. In the welding process, the separator 3 is positioned by a positioning portion provided on the frame 420. Although not illustrated, for example, a pair of protruding portions protruding inward and having a substantially L shape in plan view is provided from mutually facing corners of the inner edges of the frame 420, and the pair of protruding portions can be used as positioning portions for positioning a pair of corners of the separator 3.

In this case, the separator 3 is lowered from above the frame 420 while being positioned along the pair of positioning portions of the inner edges of the frame 420, and is mounted on the upper surface of the UEA 2. Then, for example, a predetermined welded portion is irradiated with a laser beam from above by using a laser processing machine, and the upper surface (the front surface 21b in FIG. 6) of the resin film 21 is welded (thermally bonded) to the separator 3 (rear plate 3R). Accordingly, a unit cell 1a (FIG. 3) in which the UEA 2 and the separator 3 are integrated, is manufactured.

When the fuel cell stack 100 is assembled, the unit cell 1a is adsorbed by a hand of a robot (not illustrated). Then, a plurality of the unit cells 1a are stacked while the unit cells 1a is positioned by fitting the recess of the unit cell 1a, that is, the recess 510 of the reinforcing member 51 to the guide member 45 (FIG. 5) installed in advance in the case. Accordingly, the cell stacked body 10 is formed. When the unit cells 1a are stacked, the number of movements of the hand of the robot is small and the stacking process can be completed in a short time as compared with a case where the UEA 2 and the separator 3 are separately stacked. In addition, the resin film 21 is positioned by the guide member 45, and it is not necessary to position the separator 3 by the guide member 45.

The thick reinforcing member 51 is attached to the outer edge portion of the resin film 21, and the reinforcing member 51 protrudes outward from the outer edge 21e of the resin film 21. Therefore, when an impact is applied to the fuel cell stack 100 from the outside, the tip portion of reinforcing member 51 abuts on the guide member 45. Accordingly, the movement of the cell stacked body 10 in the direction (the left-right direction and the up-down direction in FIG. 1) orthogonal to the stacking direction is prevented, and the positional displacement of the power generation cell 1 can be satisfactorily prevented.

That is, if the reinforcing member 51 is not bonded to the resin film 21, the tip portion of the thin resin film 21 abuts on the guide member 45 when an impact is applied from the outside. For this reason, the tip portion of the resin film 21 is deformed, and the position of the cell stacked body 10 cannot be restrained. In this respect, when the reinforcing member 51 is bonded to the resin film 21 as in the present embodiment, the rigidity of the tip portion of the reinforcing film 22 is increased. Therefore, the deformation of the tip portion of the resin film 21 is suppressed, and the position of the cell stacked body 10 can be satisfactorily restrained.

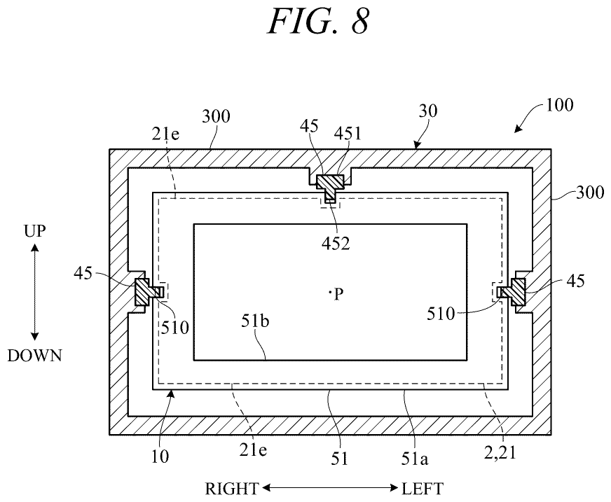

In the above description, a plurality of substantially U-shaped reinforcing members 51 are bonded to the surface of the resin film 21 corresponding to the recesses 215 of the resin film 21, but the reinforcing member 51 may be configured to cover the entire outer edge of the resin film 21. FIG. 8 is a plan view illustrating an example of the configuration. In FIG. 8, the reinforcing member 51 has a substantially rectangular outer edge 51a and the inner edge 51b, and is configured in a frame shape along the outer edge 21e of the resin film 21. In the outer edge 51a of the reinforcing member 51, the recess 510 similar to the reinforcing member 51 in FIG. 7 is provided corresponding to the position of the guide member 45, and the guide member 45 is fitted into the recess 510. By configuring the reinforcing member 51 in the frame shape as described above, the entire outer edge of the resin film 21 is reinforced, and the strength of the reinforcing film 22 can be further enhanced.

According to the present embodiment, the following operations and effects can be achieved.

(1) The power generation cell 1 includes: the UEA 2 (membrane electrode structure) that includes the MEA 20 including an electrolyte membrane, an anode electrode, and a cathode electrode, and the resin film 21 supporting the MEA 20; and the separator 3 that is made of metal and disposed opposite to the UEA 2 so as to form a flow path (anode flow path PAa, cathode flow path PAc) through which a reaction gas flows between the separator 3 and the UEA 2 (FIGS. 1 to 3). The reinforcing member 51 made of resin is bonded to the outer edge portion of the resin film 21 to form the reinforcing film 22 (FIG. 6). The reinforcing film 22 has the protruding portion 22a protruding outward from the outer edge 3e of the separator 3, and is configured such that the first region AR1 including the outer edge of the protruding portion 22a (the outer edge 51a of the reinforcing member 51) is thicker than the second region AR2 inside the first region AR1 (FIG. 6).

According to this configuration, in a case where the cell stacked body 10 and the guide member 45 are repeatedly brought into contact with each other by an external impact, not the separator 3 and the guide member 45 but the end portion of the reinforcing film 22 made of resin and the guide member 45 are brought into contact with each other. Accordingly, it is possible to prevent resin powder from being generated due to abrasion of the guide member 45. In addition, since the plate thickness of the end portion of the reinforcing film 22 is large, rigidity is high, and it is possible to prevent deformation of the end portion of the reinforcing film 22 when the reinforcing film 22 comes into contact with the guide member 45 due to an impact. As a result, the positional displacement of the cell stacked body 10 can be prevented, and leakage of the reaction gas and the like can be suppressed.

(2) The reinforcing film 22 has the reinforcing member 51 bonded to the surface of the resin film 21 (FIGS. 5 and 6). Accordingly, the rigidity of the end portion of the resin film 21 can be easily enhanced. In particular, the reinforcing member 51 has a substantially U shape corresponding to the guide member 45, and is bonded to the minimum necessary region of the resin film 21, so that the manufacturing cost of the reinforcing member 51 can be suppressed.

(3) The thickness T1 of the reinforcing member 51 is larger than the thickness T2 of the resin film 21 (FIG. 6). The outer edge 51a of the reinforcing member 51 protrudes outward from the outer edge 21e of the resin film 21 or is located at the same position as that of the outer edge 21e (FIG. 5). Accordingly, the end portion of the reinforcing member 51 having high rigidity reliably abuts on the guide member 45, and the position of the cell stacked body 10 can be firmly restrained.

(4) The separator 3 is formed in an uneven shape (FIG. 2). The outer edge portion 3g of the separator 3 extends substantially parallel to a surface of the resin film 21 at a distance of the predetermined height TO from a surface (front surface 21b) of the resin film 21 (FIG. 6). The thickness T1 of the reinforcing member 51 is equal to or less than the predetermined height TO (FIG. 6). Accordingly, the inner edge 51b of the reinforcing member 51 can be disposed inside the outer edge 3e of the separator 3 without contact between the reinforcing member 51 and the separator 3. Therefore, a region where the resin film 21 overlaps the reinforcing member 51 can be enlarged, and the reinforcing member 51 can be easily and firmly bonded to the resin film 21.

(5) The fuel cell stack 100 includes the cell stacked body 10 that is formed by stacking the above-described power generation cells 1 each having the reinforcing film 22 in a front-rear direction, and the case 30 and the end unit 40 that surround the cell stacked body 10 (FIG. 1). The resin film 21 has a substantially rectangular shape (FIG. 3). The reinforcing member 51 is disposed close to the guide member 45 provided on the inner wall surface 300a of the case 30 so as to restrict movement of the cell stacked body 10 along a plane orthogonal to the stacking direction of the power generation cells 1 (FIGS. 5 and 6). Accordingly, when an impact acts on the fuel cell stack 100 from the outside, the reinforcing member 51 abuts on the guide member 45, and the positional displacement of the cell stacked body 10 can be satisfactorily prevented.

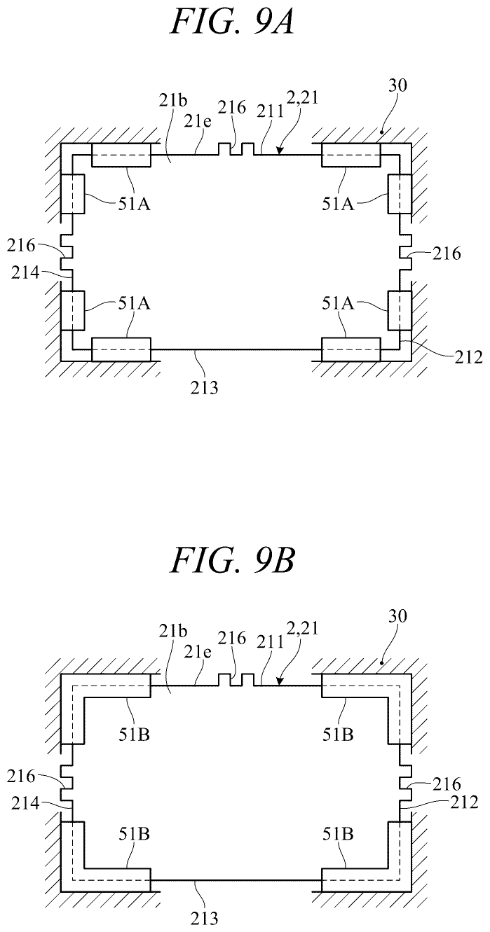

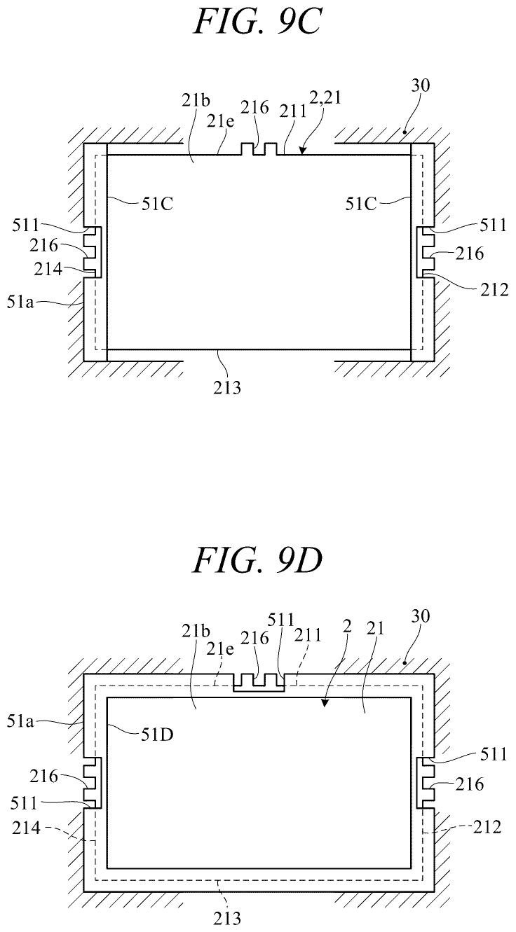

In the above description, the reinforcing member 51 is used as an impact receiving portion receiving an external impact and a positioning portion for positioning the power generation cell 1. However, the reinforcing member 51 may be used as the impact receiving portion, and the positioning of the power generation cell 1 may be performed without the reinforcing member 51. FIGS. 9A to 9D are plan views of the UEA 2 illustrating examples thereof. Also in FIGS. 9A to 9D, similarly to FIG. 4 and the like, illustration of the UEA 2 other than the outer edge portion of the resin film 21 is omitted.

In FIGS. 9A to 9D, a plurality of recesses 216 are provided in the outer edge 21e of the resin film 21. The recess 216 is configured similarly to the recess 510 in FIG. 5. Therefore, the guide member 45 (not illustrated) is fitted to the recess 215, and the UEA 2 and the power generation cell 1 are positioned. However, the guide member 45 does not have a function of receiving an impact, and thus it is not necessary to configure the guide member to be thick like the guide member 45 in FIG. 5. In this case, the guide member 45 can be constituted by, for example, a rod-shaped member having a substantially circular cross section.

Further, in FIG. 9A, reinforcing members 51A are bonded to the front surface 21b of the resin film 21 along the four sides 211 to 214 of the resin film 21. The reinforcing member 51A has a substantially rectangular shape in plan view, and has a substantially rectangular parallelepiped shape as a whole. The reinforcing members 51A are provided near four corners of the resin film 21 so as to sandwich the four corners. In the configuration of FIG. 9A, the reinforcing members 51A are provided only at necessary portions, so that the material cost of the reinforcing member 51 can be suppressed.

FIG. 9B is a first modification of FIG. 9A. In FIG. 9B, reinforcing members 51B are bonded to the front surface 21b of the resin film 21 along the four corners of the resin film 21. The reinforcing member 51B has a substantially L shape in plan view, and is provided so as to cover the entire corner. In the example of FIG. 9B, the rigidity of the entire corner is increased, which allows it to satisfactorily withstand an external impact. In addition, the number of the reinforcing members 51B can be made smaller than that in FIG. 9A.

FIG. 9C is a second modification of FIG. 9A. In FIG. 9C, reinforcing members 51C are bonded to the front surface 21b of the resin film 21 along the left side 212 and the right side 214 which are a pair of short sides of the resin film 21. The outer edge 51a of the reinforcing member 51C is provided with a recess 511, and the recess 216 of the resin film 21 is exposed via the recess 511. Both end portions of the reinforcing member 51C in a longitudinal direction abut on corners of the case 30. In the example of FIG. 9C, the number of the reinforcing members 51C can be made smaller than that in FIG. 9B.

FIG. 9D is a third modification of FIG. 9A. In FIG. 9D, a single frame-shaped reinforcing member 51D is bonded to the front surface 21b of the resin film 21 along the sides 211 to 214 of the resin film 21. The outer edge of the reinforcing member 51D is provided with the recess 511 similar to that in FIG. 9C, and the recess 216 of the resin film 21 is exposed via the recess 511. Since the reinforcing member 51D covers the entire outer edge 21e of the resin film 21, the rigidity of the entire resin film 21 can be enhanced.

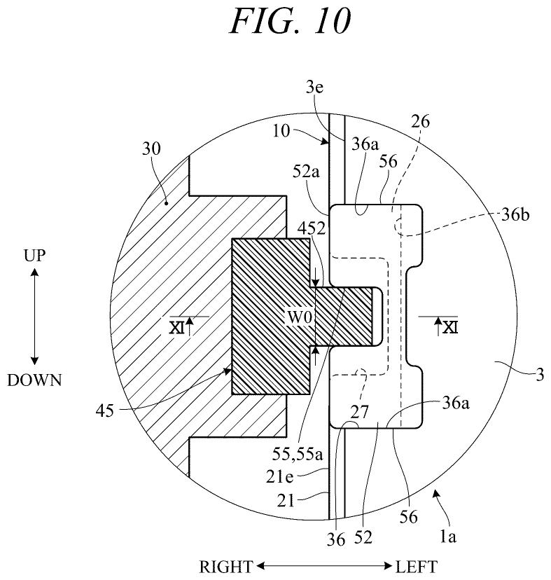

In the above, by using the manufacturing apparatus 400, the reinforcing member 51 is bonded to the surface of the resin film 21 while being positioned (FIG. 7). That is, the recess 520 of the reinforcing member 51 is fitted to the projection 425 of the frame 420 to position the reinforcing member 51. However, it requires cost to prepare the frame 420. In this regard, in order to position the reinforcing member at low cost, the positioning portion of the reinforcing member can be provided in the separator 3. This point will be described below with reference to FIGS. 10 to 14.

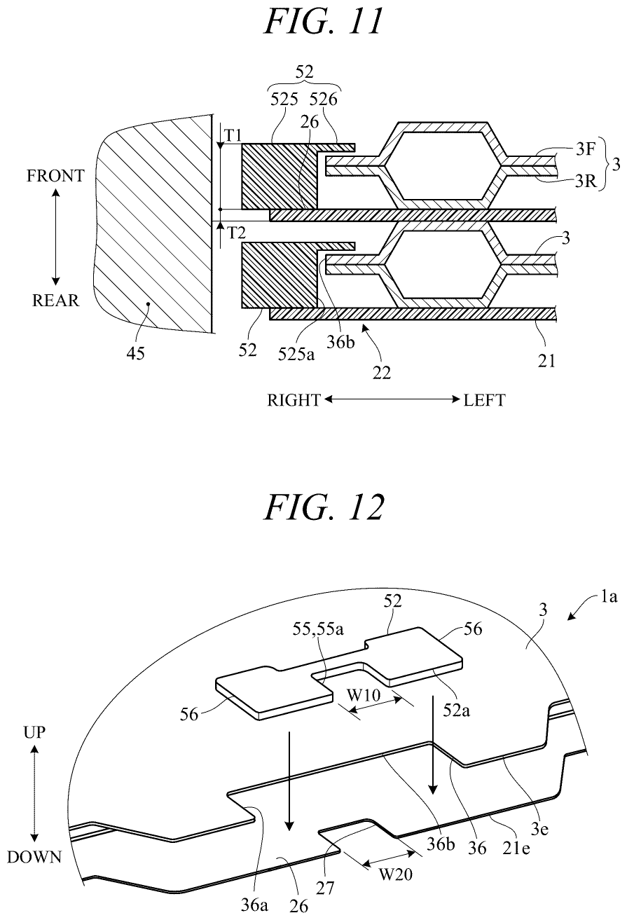

FIG. 10 is a cross-sectional view of a main part of the fuel cell stack 100 illustrating a configuration of a reinforcing member 52 positioned on the separator 3. FIG. 11 is a cross-sectional view taken along line XI-XI of FIG. 10. FIG. 12 is an exploded perspective view of the unit cell 1a included in FIG. 10. FIG. 10 is obtained by replacing the reinforcing member 51 in FIG. 5 with the reinforcing member 52, and corresponds to FIG. 5. FIG. 12 illustrates a bonding process of the reinforcing member 52. Therefore, as in FIG. 7, the direction of gravity is downward.

As illustrated in FIGS. 10 and 12, a recessed notch 36 is provided in the outer edge 3e of the separator 3. The notch 36 has a pair of side surfaces 36a facing each other and a bottom surface 36b on the back side of the notch 36. The pair of side surfaces 36a is parallel to each other. The resin film 21 protrudes outward (the right side in FIG. 10) from the separator 3, and has an exposed portion 26 exposed from the separator 3 inside the notch 36. The reinforcing member 52 made of resin is bonded to the exposed portion 26 via an adhesive. Accordingly, as illustrated in FIG. 11, the reinforcing film 22 is formed. The thickness T1 of the reinforcing member 52 is larger than the thickness T2 of the resin film 21, for example, as in FIG. 6.

As illustrated in FIG. 10, the reinforcing member 52 has a substantially U shape in plan view as viewed from the stacking direction of the power generation cells 1. The width of the reinforcing member 52 (the length in the up-down direction in FIG. 10) is equal to the width of the notch 36. The reinforcing member 52 has abutting portions 56 at both end portions in the width direction, and the abutting portions 56 abut on the side surfaces 36a of the notch 36. The length of the reinforcing member 52 (the length in the left-right direction in FIG. 10) is larger than the depth of the notch 36 (the length in the left-right direction in FIG. 10). Therefore, the reinforcing member 52 extends beyond the notch 36 in the left-right direction in FIG. 10. That is, the outer end portion (outer edge 52a) of the reinforcing member 52 extends to the right in FIG. 10 beyond the outer edge 3e of the separator 3, and the inner end portion extends to the left in FIG. 10 beyond the bottom surface 36b of the notch 36.

As illustrated in FIG. 11, the inner end portion (the left end portion in FIG. 11) of the reinforcing member 52 has a stepped shape, and includes a thick portion 525 bonded to the resin film 21 and a thin portion 526 on the inner side (left side) of the thick portion 525. The thin portion 526 extends substantially parallel to the resin film 21 so as not to interfere with the separator 3, and the separator 3 is located between the thin portion 526 and the resin film 21. There is a gap between the inner end surface 525a of the thick portion 525 and the bottom surface 36b of the notch 36 of the separator 3. The inner end surface 525a and the bottom surface 36b may abut on each other without a gap.

As illustrated in FIG. 10, the outer edge 52a of the reinforcing member 52 and the outer edge 21e of the resin film 21 are located at the same position in the left-right direction. The outer edge 52a may protrude outward (the right side in FIG. 10) from the outer edge 21e. In the outer edge 21e of the resin film 21, a recess 27 is provided at the center of the exposed portion 26 similarly to the recess 215 in FIG. 5. As illustrated in FIGS. 10 and 12, the outer edge 52a of the reinforcing member 52 is provided with a recess 55 at the center in the width direction. A width W10 of the recess 55 is smaller than a width W20 of the recess 27. Therefore, an edge 55a of the recess 55 protrudes outward (the inside of the recess 27) from the edge of the recess 27, and the entire recess 27 is covered by the recess 55. The width W20 of the recess 27 may be the same as the width W10 of the recess 55.

The width W10 of the recess 27 is equal to or substantially equal to the width W0 of the projection 452 of the guide member 45. Therefore, the recess 55 is fitted to the projection 452. Accordingly, the individual power generation cells 1 of the fuel cell stack 100, in other words, the unit cells 1a are positioned, and the movement of the cell stacked body 10 in the case 30 is restrained.

A method for manufacturing the fuel cell stack 100 includes a cell manufacturing process (cell unit manufacturing process) for manufacturing the unit cell 1a. As the cell manufacturing process, the unit cell 1a in FIG. 12 is manufactured as follows. First, the resin film 21 of the UEA 2 is joined in advance to the separator 3 (joining process). More specifically, after the UEA 2 is positioned and placed on a processing table (not illustrated), the separator 3 is positioned and placed on the upper surface of the UEA 2. Then, at a predetermined welding portion such as the corner of the separator 3, the separator 3 is welded to the resin film 21.

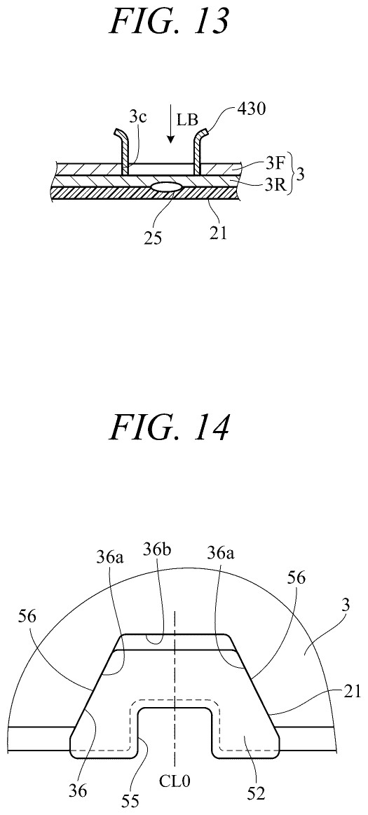

FIG. 13 is a cross-sectional view of the unit cell 1a for explaining the welding process (joining process). As illustrated in FIG. 13, a substantially circular through-hole 3c is opened in advance in a front plate 3F of the separator 3 facing the welding portion 25. A substantially cylindrical jig 430 is inserted from above through the through-hole 3c, and the jig 430 presses the rear plate 3R so that the rear plate 3R and the resin film 21 are in close contact with each other. The jig 430 can be omitted. The welding portion 25 is irradiated with a laser beam LB by using a laser processing machine attached to the hand of the robot (not illustrated). That is, the laser beam LB is emitted from above the separator 3 toward the rear plate 3R through the through-hole 3c as indicated by an arrow. Accordingly, the welding portion 25 is heated to melt a part of the resin film 21, and the rear plate 3R of the separator 3 and the resin film 21 can be welded (thermally bonded) via the welding portion 25.

When the welding process (joining process) is completed, the reinforcing member 52 is attached to the upper surface of the resin film 21 (attaching process). That is, the reinforcing member 52 is bonded to the exposed portion 26 of the resin film 21 by using an adhesive. Specifically, the reinforcing member 52 is bonded while the reinforcing member 52 adsorbed to the hand of the robot (not illustrated) is fitted into the notch 36 of the separator 3 and the pair of abutting portions 56 (FIG. 10) is caused to abut on the side surface 36a of the notch 36 to be positioned. Accordingly, the reinforcing member 52 can be easily and accurately bonded to the upper surface of the thin resin film 21. Thus, the manufacturing of the unit cell 1a is completed.

At the time of assembling the fuel cell stack 100, the unit cells 1a are adsorbed by the hand of the robot (not illustrated), the recess 55 of the reinforcing member 52 is fitted to the guide member 45 installed (fixed) in advance in the case, and a plurality of unit cells 1a are stacked while the unit cells 1a are positioned. Accordingly, the cell stacked body 10 is formed. Thereafter, a compressive load F (FIG. 2) is applied to the cell stacked body 10, and the end unit 40 is fastened to the end portion of the case 30, whereby the manufacturing of the fuel cell stack 100 is completed.

In FIG. 10, a pair of side surfaces 36a and 36a of the notch 36 of the separator 3 is parallel to each other, but the pair of side surfaces 36a and 36a may be non-parallel. FIG. 14 is a diagram illustrating an example of the configuration. In FIG. 14, the pair of side surfaces 36a and 36a are inclined at a predetermined angle with respect to a reference line CLO extending from the inside to the outside through the center of the notch 36, and extend symmetrically to each other. In other words, the notch 36 is formed to have an isosceles trapezoid shape in plan view.

Corresponding to the shape of the notch 36, a pair of abutting portions 56 and 56 of the reinforcing member 52 is also formed to be inclined at the same inclination angle as that of the pair of side surfaces 36a and 36a. Accordingly, by pressing the reinforcing member 52 against the bottom surface 36b side of the notch 36, the pair of side surfaces 36a and 36a and the pair of abutting portions 56 and 56 come into contact with each other without a gap. Therefore, the reinforcing member 52 can be positioned satisfactorily by the notch 37 without rattling.

The present embodiment can further achieve advantages and effects such as the following:

(1) The fuel cell stack 100 includes: the cell stacked body 10 that is formed by stacking a plurality of unit cells 1a in the front-rear direction; the case 30 that surrounds the cell stacked body 10; and the guide member 45 that is supported by the inner wall surface (inner surface) 300a of the case 30, extends in the front-rear direction, and restricts a position of the cell stacked body 10 (FIGS. 1 and 4). The unit cell 1a includes the UEA 2 (membrane electrode structure) that includes the MEA 20 having an electrolyte membrane, an anode electrode and a cathode electrode, and the resin film 21 supporting the MEA 20; and the separator 3 that is made of metal, disposed to face the UEA 2, and provided with the notch 36 at the outer edge 3e (FIGS. 10 and 12). The resin film 21 extends outward beyond the notch 36 and has the exposed portion 26 exposed from the separator 3 (FIGS. 10 and 12). The unit cell 1a further includes the reinforcing member 52 made of resin and bonded to the exposed portion 26 (FIGS. 10 to 12). The reinforcing member 52 has the abutting portion 56 positioned by the notch 36 and the recess 55 fitted to the guide member 45 (FIGS. 10 and 12). The edge 55a of the recess 55 is located at the same position as that of the outer edge 21e of the resin film 21, or protrudes outward from the outer edge 21e of the resin film 21 (FIG. 10).

With this configuration, in a case where the cell stacked body 10 and the guide member 45 are repeatedly brought into contact with each other by an external impact, not the separator 3 and the guide member 45 but the end portion of the resin reinforcing member 52 and the guide member 45 are brought into contact with each other. Accordingly, it is possible to prevent resin powder from being generated due to abrasion of the guide member 45. In addition, the plate thickness of the end portion of the reinforcing member 52 is thick, and thus rigidity is high. Therefore, it is possible to prevent deformation of the end portion of the reinforcing film 22 when the reinforcing film 22, which is a joined body of the resin film 21 and the reinforcing member 52, comes into contact with the guide member 45 due to an impact. As a result, the positional displacement of the cell stacked body 10 can be prevented, and leakage of the reaction gas and the like can be suppressed. Furthermore, the reinforcing member 52 is positioned by the notch 36 of the separator 3, and thus the reinforcing member 52 can be easily and accurately bonded to the thin resin film 21.

(2) The notch 36 is formed in a recessed shape in the outer edge 3e of the separator 3 (FIG. 12). The reinforcing member 52 (abutting portion 56) is formed so as to be fitted in the notch 36 (FIGS. 10 and 12). Accordingly, the pair of abutting portions 56 and 56 of the reinforcing member 52 come into contact with the pair of side surfaces 36a and 36a of the notch 36, and the reinforcing member 52 can be easily positioned.

(3) The notch 36 has a pair of side surfaces 36a and 36a which forms a recess (concave portion) and is parallel to each other, or a pair of side surfaces 36a and 36a which forms a recess (concave portion) and is non-parallel to each other (FIGS. 10 and 14). In particular, in the case of having the pair of non-parallel side surfaces 36a and 36a, the entire surface of the abutting portion 56 can be caused to abut on the side surface 36a, and the reinforcing member 52 can be positioned by the notch 37 without rattling.

(4) The reinforcing member 52 is made of the same material as that of the resin film 21, and is bonded to the exposed portion 26 (FIGS. 10 and 11). Accordingly, the reinforcing member 52 can be easily bonded, and sufficient bonding strength can be obtained.

(5) A fuel cell stack manufacturing method of manufacturing the fuel cell stack 100, which includes the cell stacked body 10 that is formed by stacking a plurality of unit cells 1a in a predetermined direction, the case 30 that surrounds the cell stacked body 10, and the guide member 45 that is supported by the inner wall surface (inner surface) 300a of the case 30, extends in the front-rear direction, and restricts a position of the cell stacked body 10, includes a unit cell manufacturing process (cell unit manufacturing process) of manufacturing the unit cell 1a (FIGS. 1 and 4). The unit cell manufacturing process includes a joining process, that is, a welding process in which the UEA 2 which includes the MEA 20 including an electrolyte membrane, an anode electrode and a cathode electrode, and the resin film 21 supporting the MEA 20, is joined with the separator 3 which is made of metal, disposed to face the UEA 2, and provided with the notch 36 at the outer edge 3e; and a bonding process (attaching process) in which the reinforcing member 52 made of resin is bonded to the exposed portion 26 of the resin film 21 which extends outward beyond the notch 36 and is exposed from the separator 3, while being positioned by the notch 36 (FIG. 12). The bonding process includes bonding the reinforcing member 52 in a state where the edge 55a of the recess 55 provided in the reinforcing member 52 so as to be fitted to the guide member 45 is located at the same position as that of the outer edge 21e of the resin film 21 or protrudes outward from the outer edge 21e of the resin film 21 (FIG. 10). Accordingly, the end portion of the reinforcing film 22 made of resin abuts on the guide member 45, so that it is possible to prevent resin powder from being generated due to abrasion of the guide member 45, and the reinforcing member 52 having high rigidity is bonded, so that it is possible to suppress deformation of the end portion of the reinforcing film 22 when an impact is applied. Furthermore, since the reinforcing member 52 is positioned by the notch 36 of the separator 3, the reinforcing member 52 is easily bonded.

The above embodiment can be modified in various forms. Below, some modified examples are described. In the above embodiment, the reinforcing film 22 as a frame member made of resin is configured by a resin film (a film member) 21 formed in a thin plate shape with an opening 21a where UEA 2 is disposed, and a reinforcing member 51 disposed in the first region AR1 and adhered to the surface of the resin film 21. However, a reinforcing member may be attached without using adhesive. The reinforcing film 22 may be configured without attaching the reinforcing member 51. For example, a thickened portion may be provided on the resin film 21 itself. That is, as long as a frame member is configured to have the protruding portion 22a that extends outward beyond the outer edge 3e (an outer edge) of the separator 3, and such that the thickness of the first region AR1 including the outer edge 51a of the protruding portion 22a is larger than the thickness of the second region AR2 located inside the first region AR1, the configuration of the frame member is not limited to the above configuration. A frame member can also be configured by forming a thickened portion on the resin film 21.

Although in the above embodiment, the thickness T1 of the reinforcing member 51 is made larger than the thickness T2 of the resin film 21, the thickness T1 may be the same as the thickness T2 or smaller than the thickness T2. Although in the above embodiment, the reinforcing member 51 is configured by a single member, the reinforcing member 51 may be formed by stacking multiple film members. For example, if the thickness T1 of the reinforcing member 51 is larger than the thickness T2 of the resin film 21, the reinforcing member 51 may be formed by stacking multiple resin films 21 formed in a substantially U-shape.

In the above embodiment, the cell stacked body 10 is configured by stacking a plurality of power generation cells 1 in the front-rear direction (a predetermined direction). However, a stacking direction is not limited to the front-rear direction. In the above embodiment, the cell stacked body 10 is surrounded by the case 30 and the end unit 40. However, the configuration of a housing is not limited to the above configuration. In the above embodiment, the outer edge 51a of the reinforcing member 51 is in contact with or close to the guide member 45 (a positioning member) supported by the case 30, restricting the movement of the cell stacked body 10 along the direction orthogonal to the stacking direction of the cell stacked body 10. However, the configuration of a positioning member is not limited to the above configuration.

The above embodiment can be combined as desired with one or more of the above modifications. The modifications can also be combined with one another.

According to the present invention, it is possible to effectively restrain a position of a cell stacked body without generating resin powder that could adversely affect power generation performance.

Above, while the present invention has been described with reference to the preferred embodiments thereof, it will be understood, by those skilled in the art, that various changes and modifications may be made thereto without departing from the scope of the appended claims.

What is claimed is:

1. A power generation cell comprising:
a membrane electrode structure including a membrane electrode assembly and a frame member made of resin to support the membrane electrode assembly, the membrane electrode structure having an electrolyte membrane and an electrode; and
a separator made of metal, disposed facing the membrane electrode structure, the separator being configured to form a flow path for a reaction gas to flow between the membrane electrode structure and the separator, wherein
the frame member includes a first region having an outer edge portion of the frame member, a second region located inside the first region, and a protruding portion provided in the first region and extending outward beyond an outer edge of the separator, and
a thickness of the frame member in the first region where the protruding portion is located, is larger than a thickness of the frame member in the second region.

2. The power generation cell according to claim 1, wherein
the frame member includes a film member provided with an opening covered by the membrane electrode assembly, and a reinforcing member disposed in the first region and bonded to a surface of the film member.

3. The power generation cell according to claim 2, wherein
a thickness of the reinforcing member is larger than a thickness of the film member, and
an outer edge of the reinforcing member protrudes outward beyond an outer edge of the film member, or is positioned at the same position as the outer edge of the film member.

4. The power generation cell according to claim 2, wherein
the separator is formed in an uneven shape,
an outer edge portion of the separator extends substantially parallel to the surface of the film member at a predetermined distance from the surface of the film member, and
a thickness of the reinforcing member is equal to or less than the predetermined distance.

5. The power generation cell according to claim 2, wherein
the film member and the reinforcing member are made of a resin material, and
the outer edge portion of the frame member is configured by bonding the reinforcing member to the surface of the film member with an adhesive.

6. The power generation cell according to claim 2, wherein
the film member includes a recessed portion provided at an outer edge of the film member,
the reinforcing member includes a recessed portion provided at an outer edge of the reinforcing member, and
the recessed portion of the reinforcing member is arranged to overlap with the recessed portion of the film member.

7. The power generation cell according to claim 6, wherein
a width of the recessed portion of the reinforcing member is narrower than a width of the recessed portion of the film member.

8. A fuel cell stack comprising:
a cell stacked body including a plurality of power generation cells stacked in a predetermined direction;
a housing surrounding the cell stacked body; and
a positioning member supported by the housing to restrict a movement of the cell stacked body in a plane orthogonal to the predetermined direction, wherein
each of the plurality of power generation cells is the power generation cell according to claim 1,
the frame member has a substantially rectangular plate shape, and
an outer edge of the protruding portion is disposed in contact with or in proximity to the positioning member.
